(19) United States
(12) Patent Application Publication
(10) Pub. No.: US 2017/0243172 A1
(43) Pub. Date: Aug. 24, 2017

(54) COGNITIVE OPTIMAL AND COMPATIBLE GROUPING OF USERS FOR CARPOOLING

(71) Applicant: International Business Machines Corporation, Armonk, NY (US)

(72) Inventors: Pankaj S. Dayama, Bangalore (IN); Vijay Ekambaram, Chennai (IN); Saravanan Sadacharam, Chennai (IN)

(73) Assignee: International Business Machines Corporation, Armonk, NY (US)

(21) Appl. No.: 15/050,642

(22) Filed: Feb. 23, 2016

(51) Int. Cl. G06Q 10/10; G06N 7/00; G06Q 30/02; G01C 21/34; G06Q 20/10

(52) U.S. Cl. CPC G06Q 10/1095; G01C 21/3438; G06Q 20/102; G06Q 30/0283; G06N 7/00; G06Q 50/01

(57) ABSTRACT

A method for scheduling a carpool, including the steps of: receiving data representing carpooling reviews of a plurality of carpool users; determining, from the carpooling review data, a plurality of questions directed to ascertaining at least one preferences of a carpool user; retrieving from a plurality of reviews of a single carpool user at least one answer, where each retrieved answer corresponds to at least one of the plurality of questions; scheduling a carpool from a plurality of available carpools, where the scheduled carpool best matches the retrieved answers of the carpool user.

### BACKGROUND

The present invention relates to a system and method of scheduling carpools generally and specifically to a system and method for generating carpools according to automatically determined user preferences.

Carpooling (also car-sharing, ride-sharing, lift-sharing), is the sharing of care rides so that more than one person travels in a car. In 2009, carpooling represented 43.5% of all trips in the United States and 10% of commute trips. The majority of carpool commutes (over 60%) are pools with family members.

By having more people using one vehicle, carpooling reduces each person's travel costs such as fuel costs, tolls, and the stress of driving. Carpooling is seen as a more environmentally friendly and sustainable way to travel as sharing rides reduces carbon emissions, traffic congestion on the roads, and the need for parking spaces. Authorities often encourage carpooling, especially during high pollution periods and high fuel prices.

Current approaches and applications for scheduling carpools are limited. Users are asked to fill out a fixed set of questions to determine the user's preferences. The application may then schedule the carpool which most closely matches the user's preferences. However, the current approach only allows a fixed, preset list of questions. Manual effort is required by the users to the fill the responses. As a result, the user's response may be incomplete, and the list of questions used may not adequately reflect the user's preferences. Furthermore, the importance of questions for a heterogenous population is not captured, and dynamic information about the user's commitments, health condition, etc. is not used.

Accordingly, there is a continued need in the art for a cognitive and distributed mobile based system which can optimally group users for car-pooling considering various dynamic contexts (including mobile data, reviews, user profiles) collected from various data sources across users.

### SUMMARY

The disclosure is directed to inventive methods and systems for a cognitive and distributed mobile based system which can optimally groups users for car-pooling considering various dynamic contexts collected from various data sources across users. Accordingly, embodiments of the disclosure are directed to a method of automatically generating a list of questions, aimed at ascertaining user preferences, from the carpooling reviews of a variety of users. Further embodiments are directed to automatically answering the list of questions for a particular user according to that user's reviews. Further embodiments are directed to automatically weighting the questions for a particular user, as well as dynamically adjusting the weights. According to an embodiment, payment for the carpool may be allotted according to user satisfaction.

Thus, according to one aspect is a non-transitory computer readable storage medium containing program code for implementing an algorithm includes the steps of: receiving data representing carpooling reviews of a plurality of carpool users; determining, from the carpooling review data, a plurality of questions directed to ascertaining at least one preferences of a carpool user; retrieving from a plurality of reviews a single carpool user at least one answer, wherein each retrieved answer corresponds to at least one of the plurality of questions; calculating, for each question corresponding to the at least one answer, a weight determined from the corresponding answer; scheduling a carpool from a plurality of available carpools, wherein the scheduled carpool best matches the weights of the single carpool user.

According to an embodiment, the algorithm further includes the steps of inputting the plurality of reviews of a single user, and a rating associated with each of the plurality of reviews, to a statistical model; and receiving from the statistical model a weight corresponding to each of a plurality of the retrieved questions.

According to an embodiment, the statistical model is a Multi Variate Regression (“MVaR”) model.

According to an embodiment, the algorithm further comprises the step of determining from the plurality of reviews the rating for at least one answer.

According to an embodiment, the algorithm further includes the step of adjusting the relative weights of the questions according to a current context of the user.

According to an embodiment, the algorithm further includes the step of calculating a utility of each passenger; allotting payment according to the utility of each passenger.

According to an embodiment, the utility of each passenger represents the degree to which each weighted question is satisfied by the scheduled carpool.

According to an embodiment, the utility is calculated after trip is finished.

According to an embodiment, the plurality of reviews of the single carpool user comprises at least one of: the user's mobile application activity, the user's social networking activity, and the user's reviews.

According to an embodiment, the user's current context is determined from at least one of the user's calendar, the user's mobile phone activity, and the user's medical prescriptions.

According to an aspect, a method for scheduling carpools includes the steps of: receiving data representing carpooling reviews of a plurality of carpool users; determining, from the carpooling review data, a plurality of questions directed to ascertaining at least one preferences of a carpool user; retrieving from a plurality of reviews of single carpool user at least one answer, wherein each retrieved answer corresponds to at least one of the plurality of questions; calculating, for each question corresponding to the at least one answer, a weight determined from the corresponding answer; scheduling a carpool from a plurality of available carpools, wherein the scheduled carpool best matches the weights of the single carpool user.

According to an embodiment, the method further includes the steps of inputting the plurality of reviews of a single user, and a rating associated with each of the plurality of reviews, to a statistical model; and receiving from the statistical model a weight corresponding to each of a plurality of the questions.

According to an embodiment, the statistical model is a Multi Variate Regression (“MVaR”) model.

According to an embodiment, the method further comprises the step of determining from the plurality of reviews a rating for at least one answer.

According to an embodiment, the method further includes the step of adjusting the relative weights of the questions according to a current context of the user.

According to an embodiment, the method further includes the step of calculating a utility of each passenger; allotting payment according to the utility of each passenger.

According to an embodiment, the utility of each passenger represents the degree to which each weighted question is satisfied by the scheduled carpool.

According to an embodiment, the utility is calculated after trip is finished.

According to an embodiment, the plurality of reviews of the single user comprises at least one of the user's mobile application activity, the user's social networking activity, and/or the user's reviews. According to an embodiment, the user's current context is determined from at least one of the user's calendar, the user's mobile phone activity, and/or the user's medical prescriptions.

These and other aspects of the invention will become clear in the detailed description set forth below.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic representation of a system for scheduling a carpool.

FIG. 2 is a flow chart of an algorithm for automatically generating a carpool questionnaire.

FIG. 3 is a flow chart of an algorithm for automatically answering the questionnaire for a particular user.

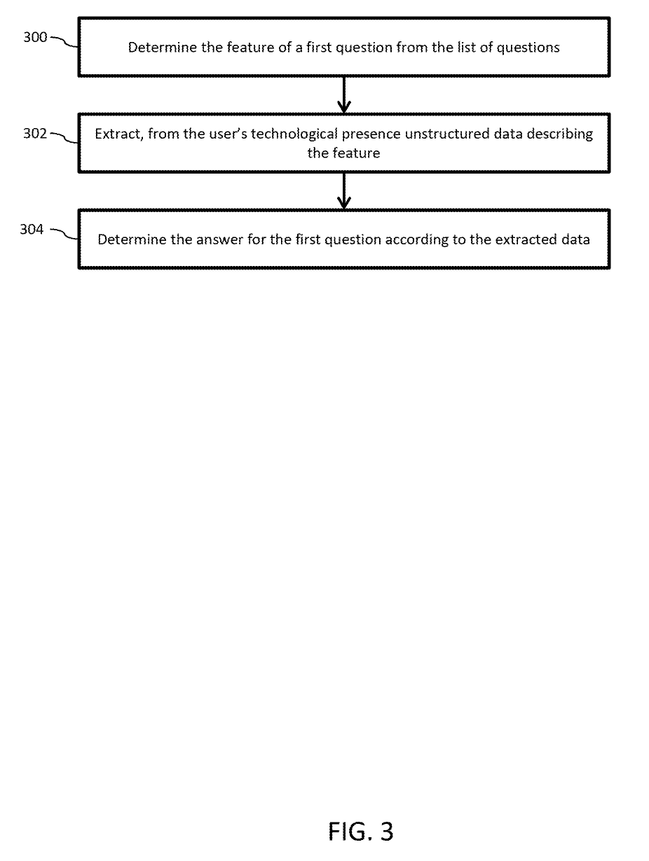

FIG. 4 is a flow chart of an algorithm for automatically determining the weights of each answer.

FIG. 5 is a flow chart of an algorithm for automatically revising the weights of each answer.

FIG. 6 is a flow chart of an algorithm for automatically scheduling a carpool.

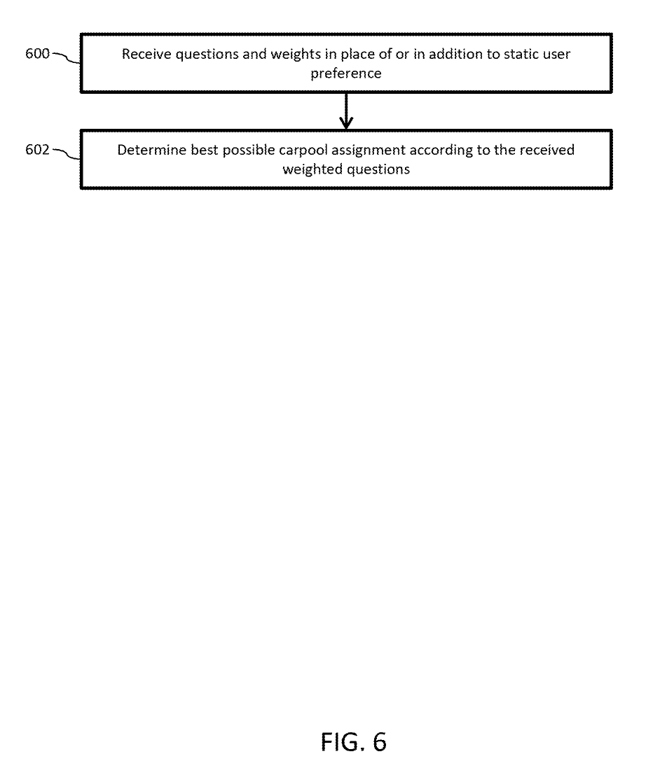

FIG. 7 is a flow chart of an algorithm for automatically scheduling payment for each user.

FIG. 8 is a system for scheduling a carpool according to an embodiment.

### DETAILED DESCRIPTION

While carpooling is widely used by commuters nation-wide, current carpooling applications are limited to a preset list of user preference questions, which fail to capture the wide-ranging preferences of carpoolers. Current applications also requires the users to manually input their own answers, and fail account for how important those answers are to the user, as well as the dynamics of the user's schedule which may elevate the importance of one preference over another at any given time.

Accordingly, there is a recognized need for a system that can dynamically generate a list of user-questions, automatically answer those questions for a particular user, adjust the weights of those questions both over time and dynamically to find carpool routes that better accommodate the needs and preferences of the users. For example, a system to automatically generate questions from carpool user-reviews would be beneficial. In recognition of that need, embodiments disclosed herein are directed to methods of creating a carpool preference list of questions from wide-ranging carpool user reviews. Additionally, it would be beneficial to automatically answer those questions for a particular user by examining that user's reviews. Accordingly, embodiments disclosed herein are directed to retrieving from a user's reviews and social networking activity, answers to the automatically generated questions.

The present disclosure is therefore directed to embodiments of a method and system for analyzing car-pooling related user reviews and user profiles to autoconstruct car-pooling related user-compatibility preferences and fine-tuning these preferences by relatively weighting them personalized to each user by considering their dynamic and personalized context.

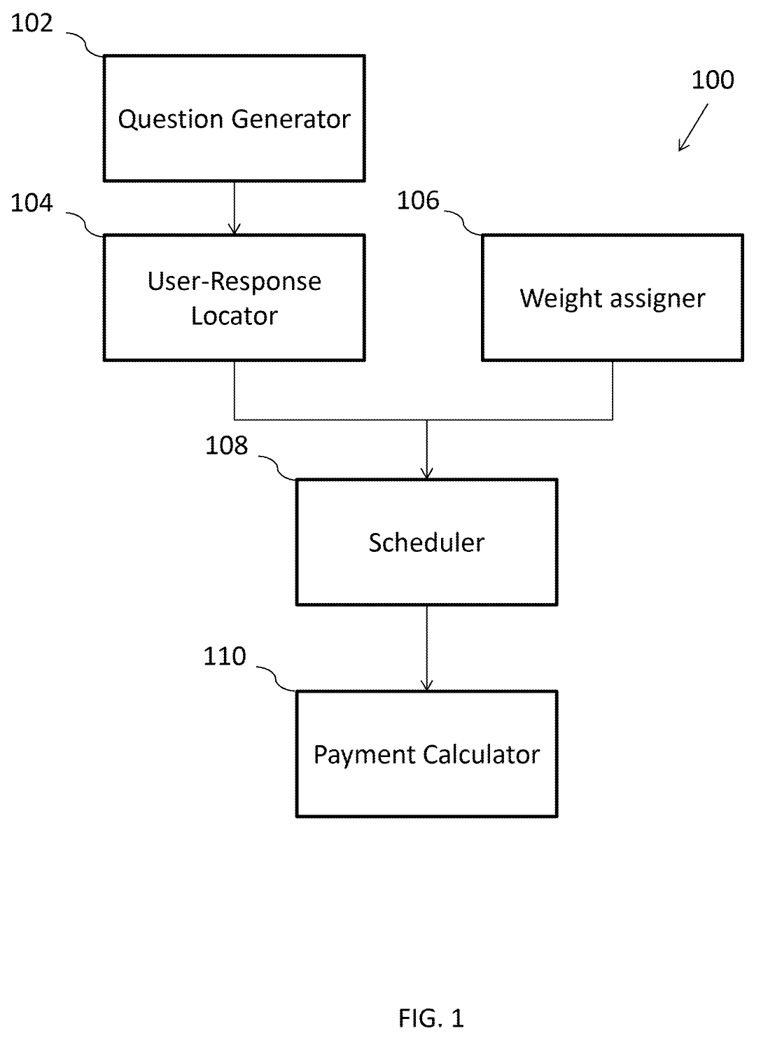

Referring now to the drawings, wherein like reference numerals refer to like parts throughout, there is seen in FIG. 1, a flowchart of scheduling system 100, comprising question generator 102 and user-response locator 104. The system can also comprise weight assigner 106, schedule 108, and payment calculator 110, among other components. According to an embodiment, question generator 102 produces a list of general questions from existing car-pool user reviews and other data, while user-response locator 104 examines a particular user's reviews (including social networking activity) and known data to automatically answer the questions produced by question generator 102. Accordingly, system 100 represents an automated system for compiling a list of general questions from a variety of users about carpooling, and then isolating a particular user's preferences regarding carpooling by matching the user's statements in reviews, social media, and other outlets against the list of automatically generated questions.

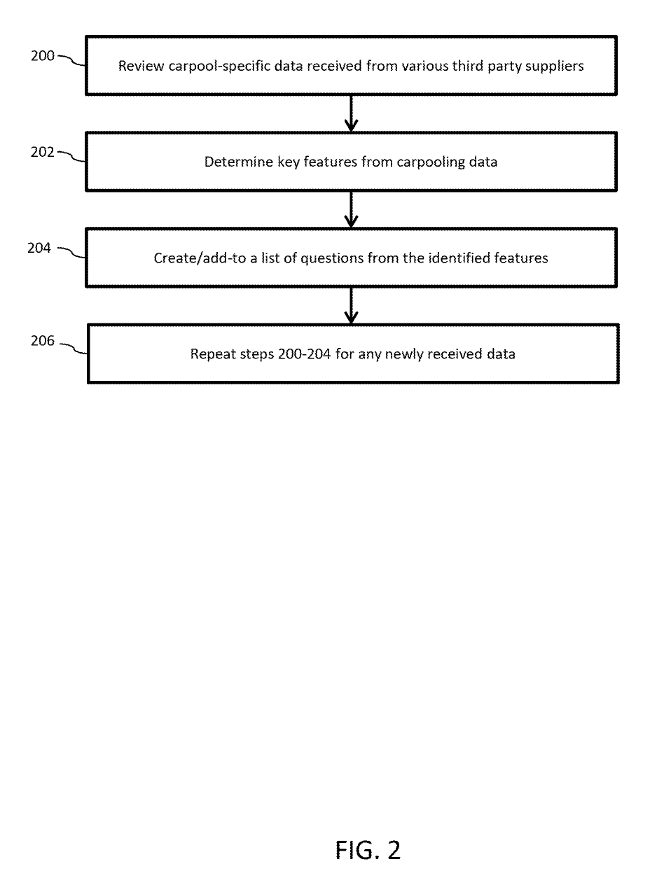

More particularly, FIG. 2 shows the steps of an algorithm for implementing question generator 104, according to an exemplary embodiment. As shown, in step 200, system 100 performs a review of data from various third party providers. This data is specific to carpooling, and may be obtained from mobile-applications dedicated to carpooling, social-networking sites, review sites, and any other source of user reviews and/or preferences regarding carpooling. This data may be received by system 100 in the form a data dump received from an external source, or the data may be retrieved by the system itself according to methods known in the art, such as via a web-crawler, for searching carpool-specific user input.

In step 202, key features from the carpooling data obtained in step 200 are obtained using a search algorithm, (e.g., a web-search algorithm such as LINGO) and a natural language processing algorithm, as are each known in the art. For example, the web-search algorithm may search the recovered data, and with the aid of the natural language processing algorithm, identify and retrieve key features from reviews and other retrieved data. It will appreciated that other algorithms could be utilized for retrieving key features the carpooling data.

In step 204, a list of questions may be created from the features identified in step 202. Because question generator 102 repeats the above steps in step 206 to continue updating the carpooling context-based question bank in an automated fashion based on the current trends and expectations (which will vary over time), if the list of questions had been already compiled, then the list will be updated in this step from any new features identified in step 202.

According to an embodiment, the list may be pre-set with a list of questions. For example, the initial list of questions may contain the following questions: (1) “Does the user like air conditioning?”; and/or (2) “Does the user prefer riding with a particular gender?”, among many other types of questions.

According to an embodiment, system 100 receives a new carpooling review dataset. Within the dataset, system 100 may retrieve the reviews that received the most likes, or by some other selection metric. Alternately, system 100 may simply input the reviews in their entirety without discriminating between which reviews received the most likes or dislikes. For example, some of the retrieved reviews might say: “I enjoyed travelling with someone who was an avid football fan,” or “It was annoying as my co-traveler was always talking on the phone.” Once the reviews are inputted, features from the reviews are identified in step 202. From these features, new questions can be generated and can be added to the question bank, such as: (3) “Does the user prefer riding with passengers that like football?”, and (4) “Does the user prefer riding with passengers that continually use their mobile phone?” among many other possible questions. In this way, the list is continually updated with new data as it is received or otherwise retrieved.

It will be appreciated that the questions need not be stored as a question, but may be stored in any format useful for later extracting user content that answers the stored question features. For example, the question “Does the user like air conditioning” may be simply stored as “air conditioning” or some other indicator sufficient to represent the question. System 100 can then later search and receive the user's information for comments regarding air conditioning or similar variations.

FIG. 2 depicts an algorithm for implementing a user-preference locator, according to an embodiment. The algorithm can be performed, for example, for each question “i” in a list of questions. At step 300 of the algorithm, the feature for question i may be determined according to methods known in the art. The question features may be, for example, mapped previously by question generator 102.

Next, in step 302, unstructured data, which describes the feature, is then extracted from the user's reviews. A user's reviews may include, but are not limited to, the user's mobile activity, social networking data, and carpooling reviews, etc. A user's reviews, for the purpose of this disclosure, need not be limited to a website that is dedicated to reviews, but may include any of the user's social media or internet activity from which the user's preferences or proclivities may be ascertained. Extracting a user's reviews may be accomplished by associating each question feature with one more keywords, such as “addicted” or “football.” Sentences from the user's reviews which contain one or more of those keywords may then be extracted. One of ordinary skill will appreciate that there are numerous ways to extract such data. For example, the user's mobile context could be retrieved from installed mobile apps. There are apps which sell user's context. Social network data and user reviews could also be retrieved from various APIs. For example, Facebook and Twitter provide APIs to extract such details. A user's friends and associated groups, corporations, etc., may also be used to determine the user's preferences.

Apart from social media and review websites, various dynamic context from various mobile data sources (such as SMS, CDR, Mobile sensors etc.) may be used to determine a user's preferences. For example, based on the user's trajectory movements, and captured mobile context, a user's preference for public transportation may be ascertained, using, i.e. a mobile device's accelerometer and GPS data, by measuring the user's routes, times, and acceleration, as well as information such as pauses in GPS location near bus or railway stations, which would determine with high probability that the user is traveling in a bus or train. This information may also be later used to revise weightages in steps 500-506.

In step 304, using the data extracted in step 302, the answer for each question may be determined. For example, a rule-based inference engine could be employed to predict the answer for each question. The rule-based inference engine could be any simple binary classifier or sentiment classifier as are known in the art. GUI ripping techniques may be applied here or in the previous step to understand the reviews posed by a user. According to one example, the features of the questions from step 300 are determined to be: (1) air conditioning preference; (2) gender preference; (3) sport preference of co-passenger; and (4) phone usage preference of co-passenger.

The answers to each of the questions may be retrieved from various data sources. For example: (1) air conditioning preference may be retrieved from the user's reviews; (2) gender preference may be retrieved from carpooling history and/or social network; (3) sport preference may be retrieved from his installed sport-related mobile apps or subscribed social networking groups; and/or (4) phone usage preference may be retrieved from mobile usage pattern and/or travel itineraries. These and many other answers may be determined and/or retrieved from one or more sources. Additionally, according to an embodiment, an answer to a question may be approximated using an algorithm that estimates an answer using one or more sources of indirect information.

According to an embodiment, that question generator 102 and/or user-response locator 104 may continually run in the background, such that they may dynamically learn the user-preference in the context of carpooling.

Referring again to FIG. 1, once the responses to the list of questions for each user are determined, the relative importance of each question to each particular user may be obtained. According to an embodiment, this can be accomplished by weight assigner 106. Weight assigner 106 may be configured to learn static weightages for the filled questions, personalized to each user, by using a model trained on the user's historical and current review data. The weights, accordingly, are indicative of the relative importance of each question to the user.

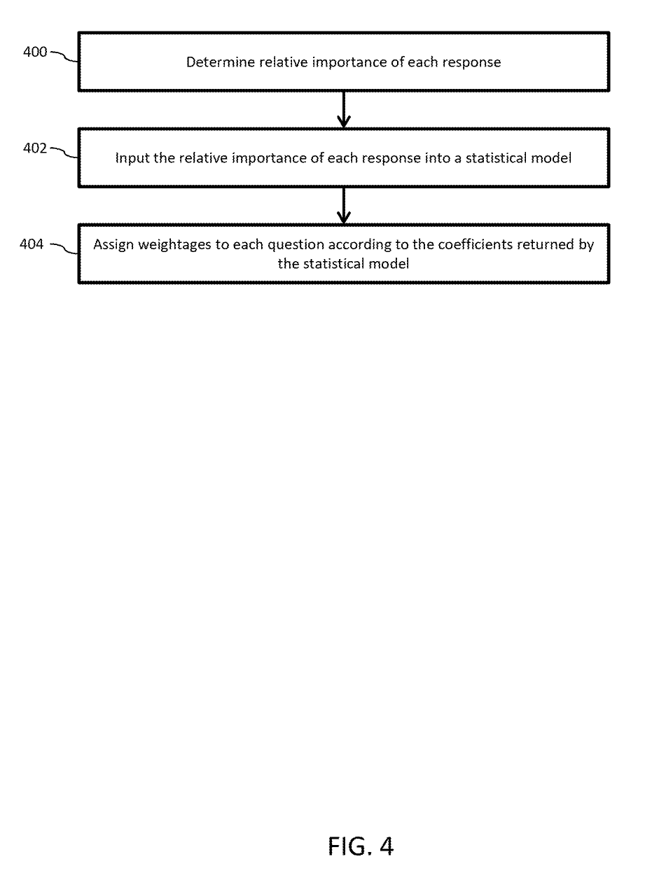

Referring to FIG. 4, according to one embodiment, are the steps of an algorithm for implementing weight assigner 106. Weight assigner 106 weights each question with respect to a particular user. As shown in step 402, this may be simply accomplished by inputting the user's historical reviews (and/or, the extracted and processed answer to each question, as processed in previous steps) and the user's rating, to a statistical model. The statistical model, (in one embodiment a Multi Variate Regression model) may then return a relative weight for question, as determined by the user's answers and the ratings associated with each. For example, if the user's answer was that the co-passenger was constantly on his/her phone, and gave the ride a 1 out of 10 rating. This data may be fed to the statistical model, which will assign a weight to the question about the co-passenger's mobile phone habits.

Note, however, that prior to step 402, in an alternate embodiment, a relative importance of each answer may be independently determined in step 400. For example, where a user has not assigned a rating to the review from which the answer was retrieved, or where the user has addressed multiple questions in a single review, additional processing may be applied to first assign an artificial “rating” to the user's review, or to the individual answers within the review, that reflects the relative importance of each answer. Natural language processing or other speech analysis processes, as are known in the art, may be used to determine the rating for each answer. This rating may then be fed to the statistical model in place of or in addition to the user's rating. One of ordinary skill will appreciate that there are variety of ways to determine the relative importance (rating) of each response.

At the outset, a uniform weightage may be applied to all questions. Alternately, the question may be initially weighted according to the number of likes received for each review from which the response was retrieved. In yet another embodiment, the question may be weighted according to the number of likes received for each review from which the initial question was retrieved—this way the importance of the question to an average user may form the initial weighting. Alternately, the question may be assigned an initial weighting according to the rating the user gave the review, or from the user's sentiment as estimated by system 100, as described above.

In step 404, the coefficients returned by the model may form the weighting for each question. Whenever the user provides new reviews and ratings, the model updates and, accordingly, the weight given to each questions by that user updates. Thus over time, relative importance of questions gets personalized to each user could be learned efficiently.

As an example of the above-described algorithm, the following initial weights may be assigned for user j: (1) Temp Preference 0.2; (2) Gender Preference 0.2; (3) Sport preference 0.2; (4) Phone usage 0.2; and (5) Avg Speed 0.2.

The following two reviews may then be received (or the pre-extracted answer data): (1) “The last trip of nearly 100 km was not very pleasant. Even though drive was good, one of the co-passengers was totally hooked on to his phone and would not stop talking about politics;” and (2) “Had a good trip. It was a smooth comfortable drive as the driver was very reasonable. We were all discussing sports and making predictions.”

From this, the following weights for each question may be determined: Review #1=(1) Temperature preference: 20; (2) Gender preference: N/A; (3) Sport preference: 0; (4) Phone usage: 1; and (5) Average speed: 60. Review #2=(1) Temperature preference: 20; (2) Gender preference: N/A; (3) Sport preference: 0; (4) Is the user a phone addict: 1; and (5) Average speed: N/A. The MVaR or other statistical model may then be trained using the weights determined above. The coefficient returned by the model form the importance score for each question.

Because the steps described above are configured to determine weighting data taken over time, they are not designed to account for pressing or current needs. Accordingly, weight assigner 106 may also revise the weightages for the dynamic real-time context, as learned from various sources.

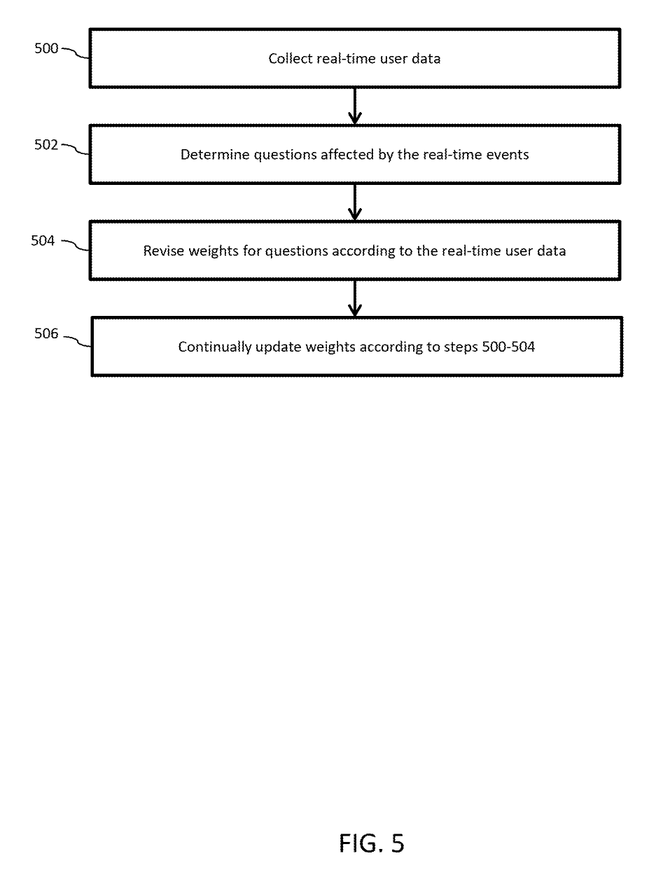

FIG. 5 shows the steps of an algorithm for revising the weightages in real-time, in accordance with an embodiment. As shown, in step 500, for example, real-time user data is collected from sources such as the mobile phone, calendar activities, medical prescriptions, etc., to understand the user's planned activities.

In step 502, the relevant questions affected by the real-time events may be found using a combination of keyword searches and a rule-based engine. Next, in step 504, the planned activities are used to revise the weights for the questions found in step 504. For example, if user j has a meeting with a client at 3 PM (retrieved from his/her calendar) and the user needs to 200 Km in 5 hours, speed becomes the primary concern rather than user-compatibility preferences. Accordingly, the weight for the average speed feature may be increased for this trip.

In step 506, weight assigner 106 continuously fine tunes the relative weights personalized to each user based on his user reviews and dynamic context.

Referring again to FIG. 1, using the dynamic car-pooling related user preference as input (instead of using traditional static user preference retrieved through manual survey) system creates the scheduling output and payment details. Any car-pooling scheduling algorithm has generally three inputs: objective function and constraint resolving function, user's request for car-pooling and user's preference. The question generator 102, user preference locator 104, and weight assigner 106, all described in detail above, generally provide additional inputs to the scheduling algorithm, here represented as scheduler 108. Using the preferences created by the modules disclosed here, the scheduling output will provide better user satisfaction as it considers user's more complete and dynamic preferences. Aside from the updated user preferences, scheduler may operate in a manner similar to current carpool scheduling algorithms, as are known in the art.

As shown, in step 600, the questions and weights are received from the user-response locator 104 and the weight assigner 106. From these inputs, the best possible carpool assignment according the weights is scheduled in step 602. This step may include in the intermediate steps of generating feasible alternatives and subjecting the results to an optimization model to ensure that the most efficient routes are provided and that the routes best match the users responses and current weighting.

For example, step 602 may include the step of generating, from the profiles of all the user's and various routes (and route features) from google maps, and inputting this information into an optimization model. This step may also include inputting to the optimization model the user utility of each user. For example, given a user's utility function (discussed in-depth below):

Uᵢⱼ=Vᵢⱼ+εᵢ (Eq. 1)

where,

Vᵢⱼ=βᵢ^{T}Xᵢⱼ (Eq. 2)

and βᵢ is an unknown vector of parameters to be estimated from historical trip data, Xᵢⱼ is a vector attributes of customer i for alternative j such as trip distance, stops, time, co-passenger, etc., and εᵢⱼ is an iid random variable. The data may be optimized as for given set of users N={1,2, . . . , n), M={1,2, . . . , m} and a given set of feasible alternatives M, the social welfare of each route may be calculated as:

Σⱼ₌₁^{m}Σᵢ₌₁ⁿ(βᵢ^{T}Xᵢⱼ+εᵢⱼ)Yⱼ (Eq. 3)

subject to feasibility constraints defined by:

Σⱼ₌₁^{m}Yⱼ23 1

Yⱼ∈{0,1} (Eq. 4)

It will be appreciated that other methods of optimization several alternative routes may be used as are known in the art.

After scheduler 108 determines the best possible assignment from the given inputs, payment calculator 110 determines the appropriate payment. Instead of a pre-determined payment model based on overall trip cost, payment may be calculated according to the relative “fairness” of the ride (i.e., accounting for degree to which user-compatibility preferences are satisfied by scheduling algorithm). In other words, the user which had a more enjoyable ride, according to their individual preferences, may pay more, while users who had a less enjoyable ride may pay less.

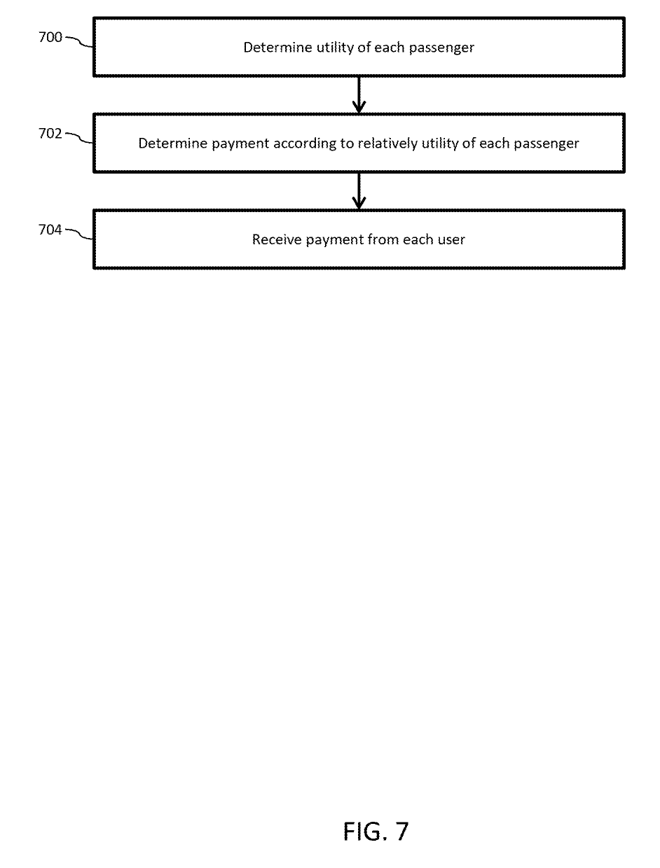

FIG. 7 shows the steps of an algorithm for implementing payment calculator 110. In step 700, the utility for each passenger is determined. Utility measures degree to which user compatibility preferences are satisfied by the scheduling algorithm. In step 702 the payment is allotted according to the relative utility of each passenger. In step 704, payment may be received by each user according to the amounts calculated in step 702.

With this in mind, one of at least two payment schemes may be implemented by payment calculator 110 for determining the payment scheme. Scheme 1 is based on the assignment of co-passengers and routes, and each user's utility is measured (by considering his/her weights). Payment is allotted proportionally to the user utility. In scheme 2 the information after the trip is actually finished is considered (such as trip time taken, user mobile call records, trip stoppages, vehicle sensor data, etc.) to compute actual realized utility for each user. Payment is proportional to user realized utility.

Thus payment may either be determined by scheduled utility or realized utility. For either scheme, payment by user j is proportional to tripcost*(user j utility)/(total utility of all passengers). For example, let the weight for each user answer wk, so the weight for answer 1 is w1, the weight for answer 2is w2, etc., and let actual measurements of the trip be x1, where the actual measurement relating answer is 1 is x1, the actual measurement for answer 2 is x2, etc. For example, x5 may be the average speed of the trip, while x4 may be mobile usage based on mobile call data. Note, that because the average speed of the trip and mobile usage are calculated with different units, and intermediate calculation may be employed to normalize the data into a unitless or otherwise consistent quantification scheme (e.g. a percentage) so that the measurements may be meaningfully added. The users realized utility, Uj may be calculated as

Ui=w1*x1+w2*x2+ (Eq. 5)

Accordingly, the payment made by user j:

Pj=Trip Cost*Uj/(Uj+Uk+Ul+Um) (Eq. 6)

where j, k, l, m are pooled together in a car.

The fairness-based payment model is based on the relative weights assigned to the questions (which is personalized to each user) and the degree to which each of the questions gets satisfied from the trip. Thus, if j has very high weightage for a particular answer and that answer is not satisfied during the trip, then he/she will pay a smaller fee. However, if k has smaller weightage to the same answer, and is not satisfied with the trip, then k may be paying the same fee (with no reductions). Since the weightage to these questions is auto-determined by system 100, system 100 makes sure that the person who gets a better user experience pays high, whereas the person who gets poorer user experience pays less. Furthermore, because the algorithm described herein automatically determines a user's satisfaction, users are prevented from taking advantage of the system by entering poor reviews of a ride in hope of paying less.

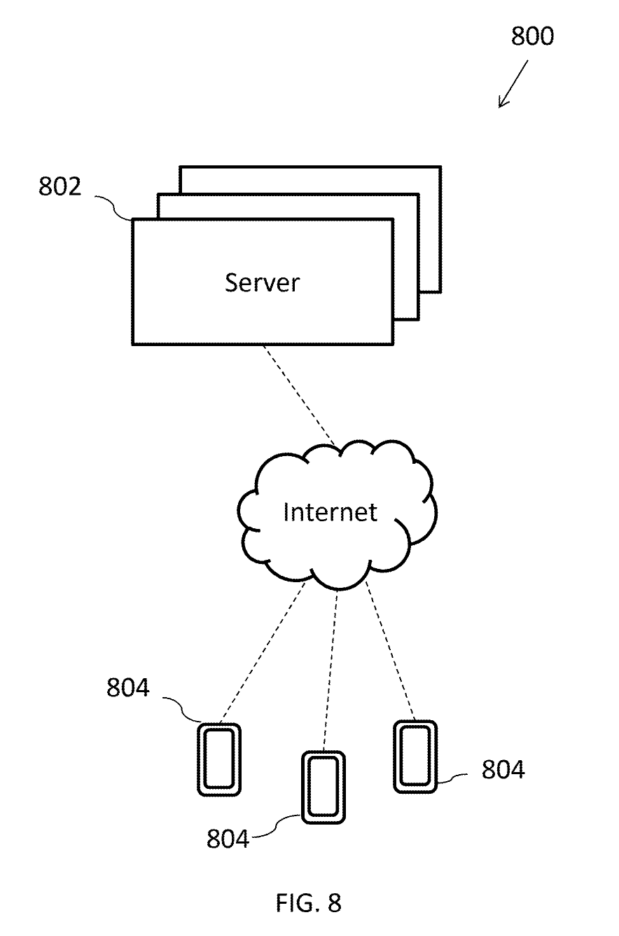

The system 100 and the above-described methods may be implemented as a computer system, shown in FIG. 8, in an embodiment. As shown in FIG. 8, computer system 800 may include at least one remote server 802, programmed to implement any embodiment of system 100, as well as, or including, any embodiment of the algorithm as defined by the above-described methods. For example, remote server 802 may be in communication with and programmed to crawl the internet to populate the global list of questions, as well as assign weights, and schedule carpools according to the methods and system 100 described above. In an alternate embodiment, computer system 800 may comprise a plurality of servers, each programmed to implement a portion of system 100 and the above-described methods. In an alternate embodiment, system 100 and/or the above-described methods may be implemented by local computer or directly on a mobile device, either in combination with, or instead of remote server 802. For example, system 100 may be distributed over remote server 802 and at least one mobile device. Alternately, the system 100 may be implemented entirely on a mobile device or a different kind of computing device.

Computer system 800 may include, or in an alternate embodiment, be in communication with, at least one mobile device 804 or any other computing device. Mobile device 804 may have a dedicated application, designed to communicate over the internet with the remote server 802. In an alternate embodiment, mobile device 804 may communicate with a local computer or another device, in combination with, or instead of remote server 802. Mobile device 804 may, in an embodiment, send to the remote server a carpooling query and receive from remote server 802 at least one carpooling option, scheduled according to the above-described system 100 and methods. Upon receiving the at least one carpooling option, the user may accept or decline, via the dedicated application, the at least one carpooling option. In an alternate embodiment, the dedicated application may not give the user the option to accept or decline and may simply proceed to notify the user of a scheduled carpool. The dedicated application may include further functionality such as allowing the user to directly rate carpools or modify the weights assigned to his or her profile. As shown in FIG. 8, system 800 may include or be in communication with a plurality of mobile devices 804, each device connecting over the internet to remote server 802, or another device, to schedule a carpool, as described in this disclosure. For example, each of mobile devices 804 may be used by a unique user to coordinate with remote server 802, or another device, to schedule a carpool according to system 100 and the above-described methods.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. At least one non-transitory computer readable storage medium together containing program code for implementing an algorithm including the steps of:
receiving data representing carpooling reviews of a plurality of carpool users;
determining, from the carpooling review data, a plurality of questions directed to ascertaining at least one preference of a carpool user;
retrieving from a plurality of reviews by a single carpool user at least one answer, each answer corresponding to at least one of the plurality of questions;
calculating, for each question corresponding to the at least one answer, a weight determined from the corresponding answer; and
scheduling a carpool from a plurality of available carpools, wherein the scheduled carpool best matches the weights of the single carpool user.

2. The algorithm of claim 1, wherein the step of calculating further comprises the steps of:
inputting the plurality of reviews of a single user, and a rating associated with each of the plurality of reviews, to a statistical model;
receiving from the statistical model a weight corresponding to each of a plurality of the questions.

3. The algorithm of claim 2, wherein the statistical model is a multi variate regression model.

4. The algorithm of claim 2, further comprising the step of determining from the plurality of reviews a rating for at least one answer.

5. The algorithm of claim 2, further comprising the steps of:
adjusting the relative weights of the questions according to a current context of the user.

6. The algorithm of claim 1, further comprising the steps of:
calculating a utility of each passenger;
allotting payment according to the utility of each passenger.

7. The algorithm of claim 6, wherein the utility of each passenger represents the degree to which each weighted question is satisfied by the scheduled carpool.

8. The algorithm of claim 6, wherein the utility is calculated after trip is finished.

9. The algorithm of claim 1, wherein the plurality of reviews of the single carpool user comprises at least one of: the single carpool user's mobile application activity, the single carpool user's social networking activity, and the single carpool user's reviews.

10. The algorithm of claim 1, wherein the user's current context is determined from at least one of: the user's calendar, the user's mobile phone activity, and the user's medical prescriptions.

11. A method for scheduling a carpool, comprising the steps of:
receiving data representing carpooling reviews of a plurality of carpool users;
determining, from the carpooling review data, a plurality of questions directed to ascertaining at least one preference of a carpool user;
retrieving from a plurality of reviews of a single carpool user at least one answer,
wherein each retrieved answer corresponds to at least one of the plurality of questions;
calculating, for each question corresponding to the at least one answer, a weight determined from the corresponding answer; and
scheduling a carpool from a plurality of available carpools, wherein the scheduled carpool best matches the weights of the single carpool user.

12. The method of claim 11, wherein the step of calculating further comprises the steps of:
inputting the plurality of reviews of a single user, and a rating associated with each of the plurality of reviews, to a statistical model;
receiving from the statistical model a weight corresponding to each of a plurality of the questions.

13. The method of claim 12, wherein the statistical model is a multi variate regression model.

14. The method of claim 12, further comprising the step of determining from the plurality of reviews a rating for at least one answer.

15. The method of claim 13, further comprising the steps of:
adjusting the relative weights of the questions according to a current context of the user.

16. The method of claim 11, further comprising the steps of:
calculating a utility of each passenger;
allotting payment according to the utility of each passenger.

17. The method of claim 16, wherein the utility of each passenger represents the degree to which each weighted question is satisfied by the scheduled carpool.

18. The method of claim 16, wherein the utility is calculated after trip is finished.

19. The method of claim 11, wherein the plurality of reviews of a single carpool user comprises at least one of: the user's mobile application activity, the user's social networking activity, and the user's reviews.

20. The method of claim 11, wherein the user's current context is determined from at least one of: the user's calendar, the user's mobile phone activity, and the user's medical prescriptions.
